(19) United States
(12) Patent Application Publication
(10) Pub. No.: US 2025/0208903 A1
(43) Pub. Date: Jun. 26, 2025

(54) EVENT-BASED AUTHORIZATION TRANSMISSION ACROSS MOBILE DEVICES

(71) Applicant: Motorola Mobility LLC, Chicago, IL (US)

(72) Inventors: Amit Kumar Agrawal, Bangalore (IN); Panduranga Reddy Pailla, Bangalore (IN); Vijayprakash Idlur, Bangalore (IN)

(73) Assignee: Motorola Mobility LLC, Chicago, IL (US)

(21) Appl. No.: 18/394,567

(22) Filed: Dec. 22, 2023

(51) Int. Cl. G06F 9/48

(52) U.S. Cl. CPC G06F 9/4856; G06F 9/4881

(57) ABSTRACT

In aspects of event-based authorization transmission across mobile devices, a first mobile device detects an event associated with a first application on the first mobile device and transmits an interface of a second application installed on the first mobile device to a second mobile device based on the event associated with the first application and a request for the second mobile device to use the second application installed on the first mobile device. When the first mobile device receives an authorization code from a remote device associated with the second application, the first mobile device transmits the authorization code to the second mobile device. When the first mobile device receives a request for a third application associated with the second application, the first mobile device transmits an interface of the third application to the second mobile device.

### BACKGROUND

Typical households include multiple mobile devices. Each of the mobile devices may include several mobile applications. In some cases, certain applications (e.g., financial applications, payment applications, shopping applications, subscription applications, etc.) are kept on one of the mobile devices in a household. The primary user of this mobile device has access to these certain applications on his or her mobile device while the other mobile devices in the household do not have access to these certain applications on their mobile devices. When a member of the household other than the primary user wants to use one of these certain applications, the member must use the primary user's mobile device. Thus, this situation presents multiple problems. For example, when the primary user is using his or her phone, the other members of the household cannot access the certain applications on the primary user's mobile device. Also, when a member of the household is using the primary user's mobile device to use one of the certain applications, the primary user is blocked from using his or her mobile device.

### BRIEF DESCRIPTION OF THE DRAWINGS

Implementations of the techniques for event-based authorization transmission across mobile devices are described with reference to the following Figures. The same numbers may be used throughout to reference like features and components shown in the Figures.

FIG. 1 illustrates an example system for event-based authorization transmission across mobile devices in accordance with one or more implementations as described herein.

FIG. 2 illustrates an example flow diagram for event-based authorization transmission across mobile devices in accordance with one or more implementations as described herein.

FIGS. 3A, 3B, 3C, and 3D illustrate example flow diagrams of event-based authorization transmission across mobile devices in accordance with one or more implementations as described herein.

FIGS. 4, 5, and 6 illustrate example methods for event-based authorization transmission across mobile devices in accordance with one or more implementations of the techniques described herein.

FIG. 7 illustrates various components of an example device that may be used to implement the techniques for event-based authorization transmission across mobile devices as described herein.

### DETAILED DESCRIPTION

Generally, a household includes multiple mobile devices where each mobile devices includes multiple mobile applications. In some cases, a user of a mobile device may share his or her mobile device with another person to let the other person use an application on the user's mobile device. Based on conventional approaches, when the user shares his or her mobile device with the other person, the user is blocked from using his or her mobile device. For example, a user can lend his or her phone to another user to let the other user access an application on the user's mobile device. Based on conventional approaches, the user loses access to his or her phone as long as another user continues to use the application on the user's mobile device. Based on conventional approaches, the other person can use his or her own mobile device to download the application and install it on a mobile device, which allows the user to continue to use his or her mobile device, but makes the other person wait while the application installs and then set up a new account for the application. Also, based on conventional approaches, when the user is already using his or her mobile device, the other person is blocked from using the user's mobile device. For example, when the user is on a video call or when a video call is scheduled to occur shortly (e.g., within the next 5 minute), then the other person is not able to access an application on the user's mobile device before or during the video call. The mobile device collaboration techniques described herein provide application and authorization transfer functionality to remedy such scenarios that arise as a result of conventional approaches.

In aspects of the described techniques, the application and authorization transfer functionality described herein enables a user to maintain control of a first mobile device while another user uses a second mobile device to access an application executing on the first mobile device. In one or more examples, the application and authorization transfer functionality is performed autonomously (e.g., without user input) via at least one mobile device. For example, an application on a first mobile device is shared with a second mobile device autonomously based on a request from the second mobile device (or user of the second mobile device) without user input at the first mobile device. Additionally, or alternatively, an authorization (e.g., an authorization code, a one-time password, a third application) is shared autonomously with the second mobile device.

In implementations, an active event is detected on a first mobile device or a scheduled event is detected on the first mobile device. Examples of the active event include an active use of a first application on the first mobile device (e.g., currently on a video call using a video call application of the first mobile device). Examples of the scheduled event include a scheduled use of the first application on the first mobile device (e.g., a scheduled video call using a video call application of the first mobile device).

In one or more examples, a request to use a second application on the first mobile device is detected. For example, the second application is identified based on the request and it is determined that use of the second application conflicts with an active event (e.g., with an ongoing video call) or with a scheduled event (e.g., with an upcoming video call). For instance, a request to use a second application is detected on the first mobile device while the user is on a video call (e.g., the first application). The sharing of the second application uses a first radio of the first mobile device (e.g., a first cellular radio, a first wireless radio) while the video call uses a second radio of the first mobile device (e.g., a second cellular radio, a second wireless radio). For example, when the sharing of the second application uses the first cellular radio, then the video call uses the first wireless radio or a second cellular radio. When the sharing of the second application uses the first wireless radio, then the video call uses the first cellular radio or a second wireless radio. In some cases, the sharing of the second application and the video call are handled over one or more WIFI® connections of the first mobile device.

In implementations, the second application is transferred from the first mobile device to a second mobile device. In one or more variations, control of the second application is shared with or transferred to the second mobile device. Additionally, or alternatively, the second application is shared with and/or a sharing interface of the second application is enabled on the second mobile device. For example, the first mobile device transfers the second application from the first mobile device to the second mobile device while maintaining the video call on the first mobile device. The first mobile device continues handling the video call and the sharing of the second application, relaying data and/or interface information of the second application to the second mobile device.

In implementations, the first mobile device monitors the sharing of the second application with the second mobile device. Based on the monitoring, aspects of the sharing of the second application can be controlled at the first mobile device. For example, sharing of the second application may include permitting the second mobile device access to a first set of one or more features of the second application, denying the second mobile device access to a second set of one or more features of the second application (e.g., different from the first set of one or more features), terminating the sharing of the second application, etc. In some examples, termination of the sharing of the second application may be based on the first mobile device detecting (e.g., based on the monitoring) that the second application is closed on the second mobile device (e.g., a user on the second mobile device closes the sharing interface of the second application). In some cases, termination of the sharing of the second application may be based on the first mobile device detecting user input at the first mobile device instructing to stop sharing the second application.

The techniques described herein provide multiple advantages. For example, the techniques enable event-based authorization transmission across mobile devices (e.g., device to device application sharing, application transfer, authorization code sharing, one-time password sharing). The application and authorization transfer functionality enables a user to continue to use a first application on his or her mobile device or maintain access to his or her mobile device (e.g., for a scheduled use of the first application, a scheduled video call) while enabling another person to interface with a second application installed on the user's mobile device. Moreover, the application and authorization transfer functionality enables the user of a first mobile device to autonomously share (e.g., without user input at the first mobile device) an authorization code with a second mobile device. Thus, the application and authorization transfer functionality described herein allows a first user to use a first mobile device however he or she wishes while concurrently enabling a second user to use a second mobile device to access a second application installed on the first mobile device, access an account associated with the first user's mobile device (e.g., where the second application and/or account is not installed on the second mobile device), and/or receive an authorization code from the first mobile device without interrupting the first user (e.g., without input from the first user).

The application and authorization transfer functionality provides an interface on the first mobile device that enables the first user to transfer a second application, transfer an authorization code associated with the second application, and/or transfer a third application associated with the second application to a second mobile device, allowing a user to use the first mobile device how he or she wishes. Additionally, or alternatively, the application and authorization transfer functionality provides an interface on the second mobile device that enables the second user to use and/or control one or more aspects of the second application on the second mobile device. Thus, the application and authorization transfer functionality enables a first user to access, via a first mobile device, a first application executing on the first mobile device and enables a second user to access, via a second mobile device, a second application executing concurrently on the first mobile device, and/or to receive an authorization (e.g., based on an authorization code and/or based on a third application). Similarly, the application and authorization transfer functionality enables a first user to maintain availability of the first mobile device (e.g., for an upcoming video call, etc.) while concurrently enabling the second user to access, via the second mobile device, authorized aspects of the second application (e.g., based on an authorization code) while the second application is executing on the first mobile device.

While features and concepts of the described techniques for event-based authorization transmission across mobile devices are implemented in any number of different mobile devices, systems, environments, and/or configurations, implementations of the techniques for event-based authorization transmission across mobile devices are described in the context of the following example devices, systems, and methods.

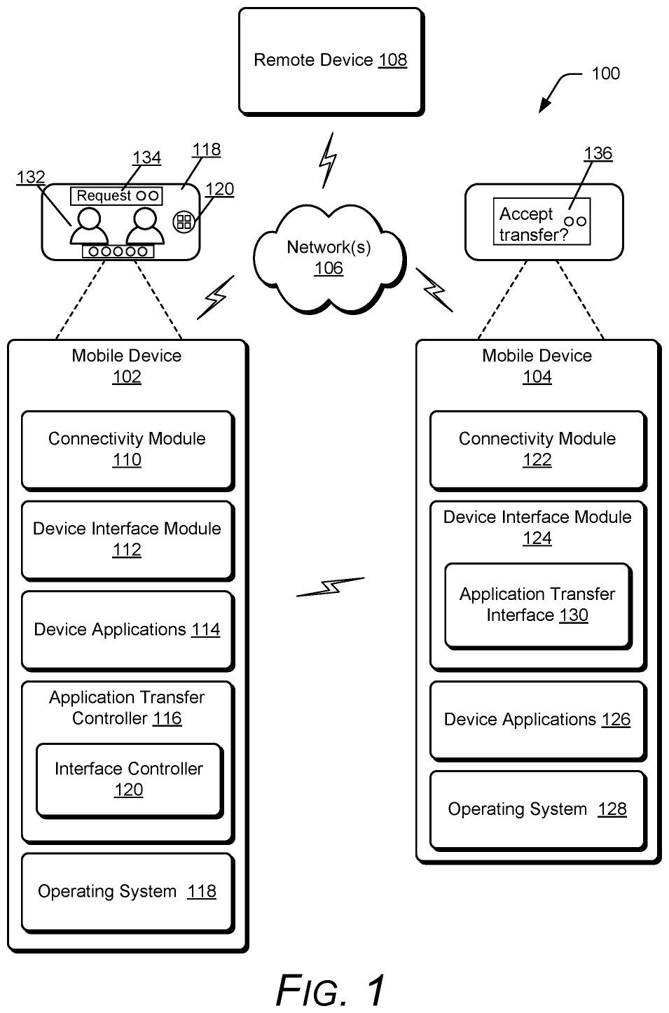

FIG. 1 illustrates an example system 100 for event-based authorization transmission across mobile devices, as described herein. The system 100 includes one or more devices, such as a mobile device 102, a mobile device 104, and/or a remote device 108. Examples of mobile devices include at least one of any type of a wireless device, mobile device, mobile phone, flip phone, client device, wearable computing device, camera device, display device, tablet computing device, communication device, entertainment device, gaming device, media playback device, any other type of computing and/or electronic device, and/or a system of any combination of such devices. Example of remote devices such as remote device 108 include at least one of any type of server device, cloud computing device, networking device, or any combination thereof.

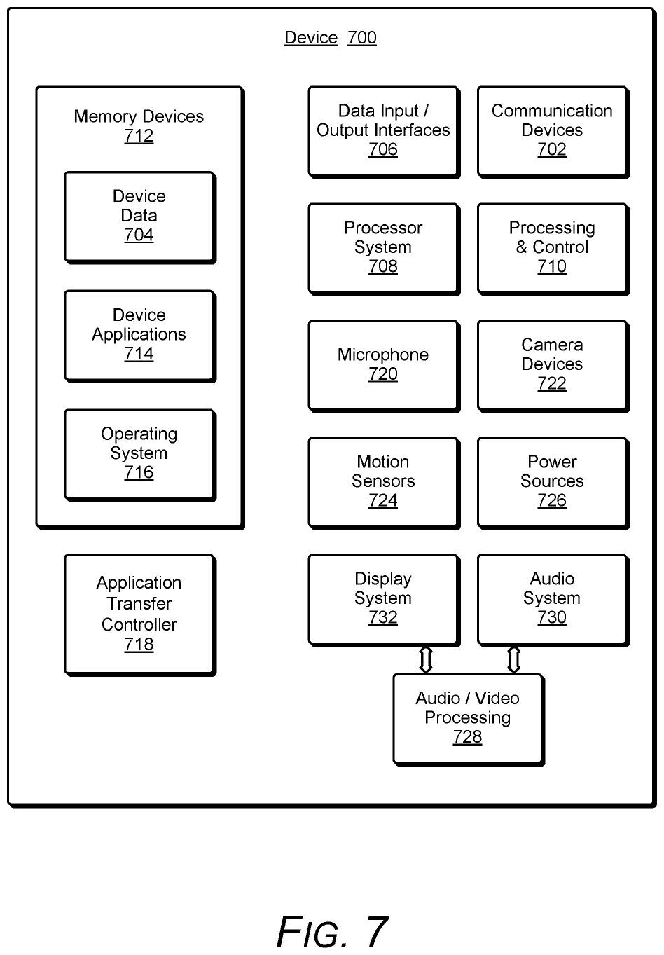

The mobile device 102 and/or the mobile device 104 is implemented with various components, such as a processor system and memory, as well as any number and combination of different components as further described with reference to the example device shown in FIG. 7. In implementations, the mobile device 102 includes various radios for wireless communication with other devices. In one or more examples, the mobile device 102 includes at least one of a BLUETOOTH® (BT) or BLUETOOTH® Low Energy (BLE) transceiver, a near field communication (NFC) transceiver, or the like. In some cases, the mobile device 102 includes at least one of a WI-FI® radio, a cellular radio, a global positioning satellite (GPS) radio, or any available type of device communication interface.

The mobile device 104 is implemented with various components, such as a processor system and memory, as well as any number and combination of the different components as further described with reference to the example device shown in FIG. 7. In implementations, the mobile device 102 is communicatively linked, either by a wired or wireless connection, to the mobile device 104. For example, the mobile device 102 and the mobile device 104 are communicatively linked via a communication network 106 and/or via direct inter-device connectivity, e.g., via direct wireless and/or wired connectivity between the mobile device 102 and the mobile device 104.

The remote device 108 is implemented with various components, such as a processor system and memory, as well as any number and combination of the different components as further described with reference to the example device shown in FIG. 7. In implementations, the remote device 108 is communicatively linked, either by a wired or wireless connection, to the mobile device 102 and/or to the mobile device 104. For example, the mobile device 102, the mobile device 104, and/or the remote device 108 are communicatively linked via a communication network 106 and/or via direct inter-device connectivity, e.g., via direct wireless and/or wired connectivity between the mobile device 102, the mobile device 104, and/or the remote device 108.

In some implementations, the devices, applications, modules, servers, and/or services described herein communicate via the communication network 106, such as for data communication between the mobile device 102 and the mobile device 104. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider.

The mobile device 102 includes various functionalities that enable the device to implement different aspects of event-based authorization transmission across mobile devices, as described herein. In the illustrated example, the mobile device 102 includes a connectivity module 110, a device interface module 112, device applications 114 (e.g., one or more device applications), and an application transfer controller 116. The connectivity module 110 represents functionality (e.g., logic, software, and/or hardware) enabling the mobile device 102 to interconnect with other devices and/or networks, such as the mobile device 104 and the communication network 106. For example, the connectivity module 110 enables wireless and/or wired connectivity of the mobile device 102. The device interface module 112 represents functionality enabling the mobile device 102 to interface with other devices. As further detailed below, the device interface module 112 enables the mobile device 102 to establish wireless and/or wired data communication with other devices, such as the mobile device 104 or similar presentation device.

Each of the connectivity module 110, the device interface module 112, the device applications 114, the application transfer controller 116, and the operating system 118 can be implemented in a variety of different manners. For example, each of the connectivity module 110, the device interface module 112, the device applications 114, the application transfer controller 116, and the operating system 118 can be implemented as multiple instructions stored on computer-readable storage media and that can be executed by a processor system of the mobile device 102. Additionally, or alternatively, each of the connectivity module 110, the device interface module 112, the device applications 114, the application transfer controller 116, and the operating system 118 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). One or more of the connectivity module 110, the device interface module 112, the device applications 114, the application transfer controller 116, and the operating system 118 can be implemented in the same manner, or the connectivity module 110, the device interface module 112, the device applications 114, the application transfer controller 116, and the operating system 118 can each be implemented in a different manner.

The mobile device 104 includes various functionality that enable the mobile device 104 to implement different aspects of event-based authorization transmission across mobile devices, as described herein. In the illustrated example, the mobile device 104 includes a connectivity module 122, a device interface module 124, device applications 126 (e.g., one or more device applications), and an operating system 128. The device interface module 124 includes an application transfer interface 130. The connectivity module 122 represents functionality (e.g., logic, software, and/or hardware) enabling the mobile device 104 to interconnect with other devices and/or networks, such as the mobile device 102 and the communication network 106. For example, the connectivity module 122 enables wireless and/or wired connectivity of the mobile device 104. The device interface module 124 represents functionality enabling the mobile device 104 to interface with other devices. As further detailed below, the device interface module 124 enables the mobile device 104 to establish wireless and/or wired data communication with other devices, such as the mobile device 102 or similar devices. The application transfer interface 130 provides an interface to the application transfer controller 116 of the mobile device 102. In one or more examples, the mobile device 104 includes an instance of the application transfer controller 116 that provides the application transfer interface 130, enabling the mobile device 104 to interact with the application transfer controller 116 of the mobile device 102.

The device applications 114 represent functionality for performing different computing tasks via the mobile device 102, such as gaming, media consumption (e.g., content streaming), productivity tasks (e.g., word processing, content generation, data analysis, etc.), content generation, web browsing, communication with other devices, and so forth. Similarly, the device applications 126 represent functionality for performing different computing tasks via the mobile device 104, such as gaming, media consumption (e.g., content streaming), productivity tasks (e.g., word processing, content generation, data analysis, etc.), content generation, web browsing, communication with other devices, and so forth.

The operating system 118 manages hardware, software, and firmware resources in the mobile device 102. The operating system 118 manages the device applications 114 running on the mobile device 102 and operates as an interface between device applications 114 and hardware components of the mobile device 102. Similarly, the operating system 128 manages hardware, software, and firmware resources in the mobile device 104. The operating system 128 manages the device applications 126 running on the mobile device 104 and operates as an interface between device applications 126 and hardware components of the mobile device 104.

The mobile device 102 and/or the mobile device 104 can include and implement device applications 114 and/or device applications 126, such as any type of messaging application, email application, video communication application, cellular communication application, music/audio application, gaming application, median application, social platform application, and/or any other of the many possible types of device applications. Many of the device applications 114 have an associated application user interface that is generated and displayed for user interaction and viewing, such as on a display screen of the mobile device 102 and/or on a display of the mobile device 104. Generally, an application user interface, or any other type of video, image, graphic, and the like is digital image content that is displayable on the display screen of the mobile device 102 and/or on the display of the mobile device 104.

Each of the connectivity module 122, the device interface module 124, the device applications 126, the operating system 128, and the application transfer interface 130 can be implemented in a variety of different manners. For example, each of the connectivity module 122, the device interface module 124, the device applications 126, the operating system 128, and the application transfer interface 130 can be implemented as multiple instructions stored on computer-readable storage media and that can be executed by a processor system of the mobile device 102. Additionally, or alternatively, each of the connectivity module 122, the device interface module 124, the device applications 126, the operating system 128, and the application transfer interface 130 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). One or more of the connectivity module 122, the device interface module 124, the device applications 126, the operating system 128, and the application transfer interface 130 can be implemented in the same manner, or can each be implemented in a different manner.

In one or more examples, a connectivity session is established between the mobile device 102 and the mobile device 104 that enables the mobile device 102 to send output content to and/or receive output content from the mobile device 104. In one or more implementations, the connectivity session is established via intercommunication between the device interface module 112 of the mobile device 102 and the device interface module 112 of the mobile device 104. The output content is any type of digital video, images, audio, application interfaces, etc. In one or more implementations, the mobile device 104 can output the output content at the device.

In the example system 100 for event-based authorization transmission across mobile devices, the mobile device 102 and the mobile device 104 are mobile devices that incorporate application and authorization transfer functionality. At least one of the mobile device 102 or the mobile device 104 implements an instantiation of an application transfer controller 116 (e.g., as a device application 114). The application transfer controller 116 represents functionality (e.g., logic, software, and/or hardware) enabling implementation of described techniques for event-based authorization transmission across mobile devices. The application transfer controller 116 can be implemented as computer instructions stored on computer-readable storage media and can be executed by a processor system of the mobile device 102 and/or of the mobile device 104. Alternatively or in addition, the application transfer controller 116 can be implemented at least partially in hardware of a device.

In one or more implementations, the application transfer controller 116 includes independent processing, memory, and/or logic components functioning as a computing and/or electronic device integrated with the mobile device 102 and/or with the mobile device 104. Alternatively or in addition, the application transfer controller 116 can be implemented in software, in hardware, or as a combination of software and hardware components. In one or more examples, the application transfer controller 116 is implemented as a software application or module, such as executable software instructions (e.g., computer-executable instructions) that are executable with a processor system of the mobile device 102 and/or the mobile device 104 to implement the techniques and features described herein. As a software application or module, the application transfer controller 116 is stored on computer-readable storage memory (e.g., memory of a device), or in any other suitable memory device or electronic data storage implemented with the module. Alternatively or in addition, the application transfer controller 116 is implemented in firmware and/or at least partially in computer hardware. For example, at least part of the application transfer controller 116 is executable by a computer processor, and/or at least part of the application transfer controller 116 is implemented in logic circuitry.

In one or more implementations, the mobile device 102 and the mobile device 104 belong to a group of devices (e.g., a family group of devices). In one or more variations, the mobile device 102 is a group leader device that is configured (e.g., via the application transfer controller 116) to control one or more aspects of the group such as adding a device to the group, removing a device from the group, configuring group settings, setting device permissions within the group, and the like. In one or more examples, transferring an application from the mobile device 102 to the mobile device 104 is based on the application transfer controller 116 determining that the mobile device 102 and the mobile device 104 being in the same group of devices.

In implementations, the application transfer controller 116 detects an event associated with a first application 132 on the mobile device 102. The event includes an active use of the first application 132 on the mobile device 102 such as an active telephone call, an active video call, an active mobile application, and the like. Additionally, or alternatively, the event includes a scheduled use of the first application 132 on the mobile device 102 (e.g., a scheduled call, a scheduled video call, etc.) that conflicts with the use of a second application 134 on the mobile device 102.

In the illustrated example, the application transfer controller 116 detects that the mobile device 102 executes the first application 132. The application transfer controller 116 detects a request to use the second application 134 on the mobile device 102. The request to use the second application 134 includes at least one of a notification on a display of the mobile device 102 or a message received at the mobile device 102.

As shown, the application transfer controller 116 includes an interface controller 120 to enable the application and authorization transfer functionality described herein. In one or more examples, the interface controller 120 enables a user of the mobile device 102 to transfer an interface of the second application 134 to the mobile device 104. For example, the user of the mobile device 102 drags the second application 134 (e.g., drags a request or notification associated with the second application 134) to the interface controller 120 and the interface controller 120 transfers the interface of the second application 132 to the mobile device 104, enabling a user of the mobile device 104 to control one or more aspects of the second application 132. In the illustrated example, a notification of a request to use the second application 134 appears on the screen of the mobile device 102 requesting that access to the second application 134 be shared with another device (e.g., mobile device 104). In response, the user slides the notification of the second application 134 to a graphic displayed on the mobile device 102 that represents at least one function of the interface controller 120. When the interface controller 120 detects that the notification of the second application 134 is dragged to the graphic, the interface controller 120 initiates the transfer of the second application 134 to the mobile device 104.

In implementations, the interface controller 120 transmits an interface of the second application 134 to the mobile device 104 based on the event associated with the first application 132 and the request to use the second application 134 on the mobile device 102. In implementations, the application transfer controller 116 transmits a message to the mobile device 104 requesting that the mobile device 104 receive the interface of the second application 132. As shown, the application transfer interface 130 displays a prompt 136 on a screen of the mobile device 104. The application transfer interface 130 generates the prompt 136 in response to the message from the application transfer controller 116 requesting that the mobile device 104 receive the interface of the second application 132. In one or more examples, the interface of the second application 134 is transmitted in response to an approval of the request received at the mobile device 102 and/or in response to an approval of the prompt 136 displayed at the mobile device 104.

In the illustrated example, the application transfer interface 130 of the mobile device 104 receives the interface of the second application 134 from the interface controller 120. In one or more examples, the application transfer interface 130 provides an interface to the second application 134 executing on the mobile device 102.

The interface of the second application 134 transmitted to the mobile device 104 differs from an interface of the second application 134 on the mobile device 102. For example, the transmission of the interface of the second application 134 includes the interface controller 120 transmitting instructions for providing the interface of the second application 134 on the mobile device 104 via the application transfer interface 130, while the second application executes on the mobile device 102. For example, the application transfer interface 130 receives the instructions for the interface of the second application 134 from the interface controller 120 and the application transfer interface 130 processes the instructions and provides the interface of the second application 134 on the mobile device 104 based on the processing of the instructions. The processing of the instructions includes at least an initial set of instructions for providing the interface of the second application 134, and/or a continuous stream of instructions for providing the interface of the second application 134 on the mobile device 104.

In implementations, the application transfer controller 116 receives an authorization code from the remote device 108 (e.g., a remote device associated with the second application). For example, the user of the mobile device 104 triggers a request for the authorization code based on the user interfacing with the second application (e.g., via application transfer interface 130). Accordingly, the mobile device 102 receives the authorization code from the remote device 108 and the interface controller 120 transmits the authorization code to the second mobile device. In some cases, the first application and the second application execute concurrently on the first mobile device.

In one or more examples, the application transfer controller 116 displays, in response to receiving the authorization code from the remote device 108, a prompt on a display of the mobile device 102 requesting approval of the authorization code being transmitted to the mobile device 104. The application transfer controller 116 transmits the authorization code based on the application transfer controller 116 detecting an approval to transmit the authorization code in response to display of the prompt.

In one or more examples, the application transfer controller 116 transmits at least one of the interface of the second application or the authorization code automatically based on a preconfigured policy. In some cases, the preconfigured policy includes at least one of a list of authorized mobile devices or a list of unauthorized mobile devices, where the application transfer controller 116 transmits at least one of the interface of the second application or the authorization code automatically based on the mobile device 104 being on the list of authorized mobile devices and/or not being on the list of unauthorized mobile devices. In some cases, the preconfigured policy includes at least one of a list of authorized applications or a list of unauthorized applications, where the application transfer controller 116 transmits at least one of the interface of the second application or the authorization code automatically based on the second application being on the list of authorized applications and/or the second application not being on the list of unauthorized applications.

In one or more examples, the application transfer controller 116 receives the authorization code via the second application on the mobile device 102 and transmits the authorization code to the mobile device 104 via the interface of the second application on the mobile device 104. Additionally, or alternatively, the application transfer controller 116 receives the authorization code from the remote device 108 via a text messaging application of the mobile device 102 and transmits the authorization code to the mobile device 104 via the second application based on the second application acquiring the authorization code from the text messaging application. In some cases, the application transfer controller 116 transmits the authorization code to the mobile device 104 via text message.

In one or more examples, the application transfer controller 116 transmits an interface of a third application installed on the mobile device 102 to the mobile device 104 based on the event associated with the first application and a second request by the second application (via the mobile device 104) to use the third application of the mobile device 102 on the mobile device 104. In some cases, the mobile device 102 transmits at least one of the interface of the second application or the interface of the third application automatically based on a preconfigured policy. The preconfigured policy may include at least one of a list of authorized mobile devices or a list of unauthorized mobile devices, where the application transfer controller 116 transmits at least one of the interface of the second application or the interface of the third application automatically based on the mobile device 104 being on the list of authorized mobile devices and/or based on the mobile device 104 not being on the list of unauthorized mobile devices. In some cases, the preconfigured policy may include at least one of a list of authorized applications or a list of unauthorized applications, where the application transfer controller 116 transmits at least one of the interface of the second application or the interface of the third application automatically based on at least one of the second application or the third application being on the list of authorized applications or based on at least one of the second application or the third application not being on the list of unauthorized applications.

In implementations, the first application 132 utilizes a first wireless technology and the second application 134 utilizes a second wireless technology different from the first wireless technology. The mobile device 102 and the mobile device 104 each include at least one wireless radio (e.g., WI-FI® radio) and/or at least one cellular radio. In the illustrated example, the first application 132 is a video call application that utilizes at least one of a voice over internet protocol (VOIP) connection, a cellular connection, or a wireless connection. The second application 134 utilizes at least one of the VOIP connection, the cellular connection, or the wireless connection. For example, when the first application 132 utilizes the wireless radio, the second application 134 utilizes the cellular radio. When the first application 132 utilizes the cellular radio, the second application 134 utilizes the wireless radio. In one or more examples, the mobile device 102 includes at least two wireless radios and/or at least two cellular radios (e.g., two subscriber identity module (SIM) cards). Thus, when the first application 132 utilizes a first wireless radio, the second application 134 utilizes the cellular radio or a second wireless radio. Additionally, or alternatively, when the first application 132 utilizes a first cellular radio, the second application 134 utilizes a wireless radio or a second cellular radio.

In implementations, the interface controller 120 receives, from the application transfer interface 130, monitoring information associated with a use of the second application 134 (and/or the third application) on the mobile device 104. In one or more examples, the interface controller 120 terminates transmission of the interface of the second application 134 (and/or the third application) to the mobile device 104 based on the monitoring information transmitted by the application transfer interface 130. In one or more variations, the monitoring information received by the interface controller 120 indicates that the second application 134 (and/or the third application) is closed on the mobile device 104. In response, the interface controller 120 terminates access to the second application 134 (and/or the third application) on the mobile device 104. Additionally, or alternatively, the interface controller 120 terminates transmission of the interface of the second application 134 (and/or the third application) to the mobile device 104 based on user input received at the mobile device 102. For example, the user of the mobile device 102 provides an input (e.g., presses an on-screen button, speaks a voice command, or otherwise interacts with of the second application 134 and/or of the interface controller 120) that modifies the transmission of the second application 134 (and/or the third application) to the mobile device 104. The modification of the transmission of the second application 134 (and/or the third application) includes at least one of a transfer of control of the second application 134 (and/or the third application) back to the mobile device 102, removal of access to the second application 134 (and/or the third application) on the mobile device 104, termination of the sharing of the second application 134 (and/or the third application) to the mobile device 104, and/or termination of the second application 134 (and/or the third application) on the mobile device 102.

In implementations, the interface controller 120 provides media content (e.g., audio content and/or video content) to the mobile device 104 (e.g., to the device interface module 124). For example, the sharing of the second application 134 (and/or the third application) to the mobile device 104 can include the interface controller 120 sharing media content of the second application 134 (and/or the third application) with the mobile device 104. For instance, the interface controller 120 identifies the media content of the second application 134 (and/or the third application) and streams the identified media content to the mobile device 104. Additionally, or alternatively, the device interface module 124 identifies media content and/or user input associated with a user of the mobile device 104 interacting with the shared second application 134 (and/or the third application) on the mobile device 104 and streams the media content and/or user input to the mobile device 102. For instance, the device interface module 124 can identify a user input at the mobile device 104 (e.g., a user of the mobile device 104 touching an on-screen button or clicking a physical button of the mobile device 104) and the device interface module 124 streams or relays the user input to the application transfer controller 116. Additionally, or alternatively, the device interface module 124 identifies location information of the user input (e.g., a location on the screen of the mobile device 104 where the user touched the on-screen button) and streams or relays the location information to the application transfer controller 116.

In implementations, the second application 134 (and/or the third application) can include a shopping application, a media streaming application, a payment application, or any other mobile application associated with a user account. In some cases, the second application 134 (and/or the third application) is installed and available on the mobile device 102, but is not installed and/or is not available to the mobile device 104. In one or more examples, a shopping application is installed on the mobile device 102 and is implemented based on being logged in with a user account. The user of the mobile device 102 knows or has the credentials to log in with the user account (e.g., user name, password, biometric login, etc.). The mobile device 104 can install the shopping application, but cannot implement or interact with the shopping application because the user of the mobile device 104 lacks the credentials to login to access the account. However, the application transfer controller 116 enables the user of the mobile device 104 to access the account information of the shopping application. For example, the application transfer controller 116 enables a user of the mobile device 102 to share the shopping application (e.g., the second application 134 and/or the third application) with the mobile device 104, enabling the user of the mobile device 104 to access aspects of the shopping application based on the account information, including the user of the mobile device 104 interacting with the user interface of the shopping application, adding items to a shopping cart, and/or placing orders on the shopping application through the account. In implementations, the device interface module 124 provides a notification of a shopping cart to the mobile device 102, indicating the items in the shopping cart and requesting approval of the order being placed. Additionally, or alternatively, the shopping application may request an authorization code to access an aspect of the shopping application (e.g., to checkout, to pay for an order, etc.). In implementations, the device interface module 124 enables a user of the mobile device 104 to receive an authorization code sent to the mobile device 102 by the remote device 108. Thus, a user of the mobile device 104 using an interface of the shopping application displayed on the mobile device 104 and provided by the interface controller 120, where the shopping application executes on the mobile device 102, may trigger the shopping application to request an authorization code. The mobile device 102 receives the authorization code from the remote device 108 and, in some examples, autonomously transmits the authorization code to the mobile device 104 to access the authorized aspect of the shopping application. Once the order is approved via the application transfer controller 116, the device interface module 124 provides a notification to the mobile device 102 that the order has been placed. Accordingly, the user of the mobile device 102 can terminate the sharing of the shopping application based on the notification that the order has been placed.

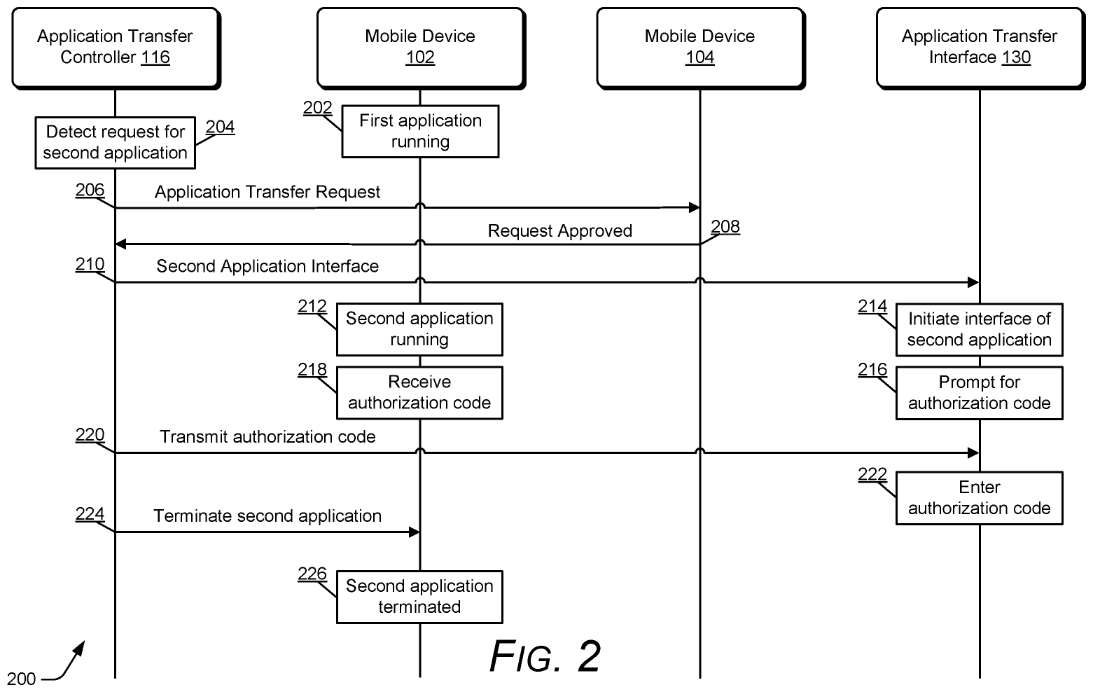

FIG. 2 illustrates an example flow diagram 200 for event-based authorization transmission across mobile devices. The order in which the flow diagram is described is not intended to be construed as a limitation, and any number or combination of the flow diagram operations described herein may be performed in any order to perform a method, or an alternate method.

At 202, a first application is running on the mobile device 102. For example, the application transfer controller 116 determines that the first application 132 is running on the mobile device 102.

At 204, the application transfer controller 116 detects a request to use a second application on the mobile device 102. In one or more examples, the request includes a notification that appears on a screen of the mobile device 102.

At 206, the application transfer controller 116 transmits an application transfer request to the mobile device 104. For example, the application transfer controller 116 generates and transmits the application transfer request to the mobile device 104. In implementations, a user of the mobile device 102 initiates an application transfer by providing user input at the mobile device 102. For example, the user provides a user input in response to a notification of the request to use the second application 134 appearing on a screen of the mobile device 102. In one or more variations, the application transfer interface 130 receives the application transfer request and displays a notification (e.g., the prompt 136) on a screen of the mobile device 104.

At 208, the mobile device 104 transmits an approval of the application transfer request to the mobile device 102. As shown, the approval of the application transfer request is received and/or processed by the application transfer controller 116. For example, the application transfer controller 116 receives the approval and initiates transfer of the second application 134 to the mobile device 104.

At 210, the application transfer controller 116 transfers an interface of the second application to the application transfer interface 130 of the mobile device 104. For example, the application transfer controller 116 transfers instructions to the application transfer interface 130 to provide an interface of the second application 134 on the mobile device 104 while the second application 134 executes on the mobile device 102. Accordingly, the interface of the second application 134 is based on the application transfer controller 116 handling instructions and/or data communications between the second application 134 and the application transfer interface 130.

At 212, the second application is running on the mobile device 102. For example, the application transfer controller 116 detects that the second application 134 is running on the mobile device 102 based on receiving the approval of the application transfer request.

At 214, the application transfer interface 130 initiates an interface of the second application. For example, the application transfer interface 130 receives instructions from the application transfer controller 116 to provide an interface of the second application 134 on the mobile device 104.

At 216, the application transfer interface 130 detects a prompt for an authorization code. For example, the application transfer interface 130 detects that the second application is requesting an authorization code to access a feature (e.g., a secure feature, an authorized feature) of the second application.

At 218, the mobile device 102 receives an authorization code. For example, the mobile device 102 receives an authorization code from a remote device (e.g., an authentication server, the remote device 108).

At 220, the application transfer controller 116 transmits the authorization code to the application transfer interface 130. Additionally, or alternatively, the application transfer controller 116 transmits the authorization code to the mobile device 104. In some cases, the application transfer controller 116 transmits the authorization code autonomously (e.g., without user input).

At 222, the application transfer interface 130 enters the authorization code. For example, the application transfer interface 130 enters the authorization code at the second application. In some cases, the application transfer interface 130 enters the authorization code autonomously (e.g., without user input). In variations, the application transfer controller 116 detects that the authorization code is received and/or entered at the mobile device 104 (e.g., by a user).

At 224, the application transfer controller 116 provides a termination request to the mobile device 102. For example, the application transfer controller 116 sends a termination request the operating system 118 of the mobile device 102 instructing the operating system 118 to end execution of the second application 134 on the mobile device 102 based on monitoring information indicating that the interface of the second application 134 is closed on the mobile device 104.

At 226, the mobile device 102 terminates the second application. For example, in response to receiving the termination request from the application transfer controller 116, the operating system 118 of the mobile device 102 terminates the second application 134. As a result, access to the second application 134 on the mobile device 104 is terminated.

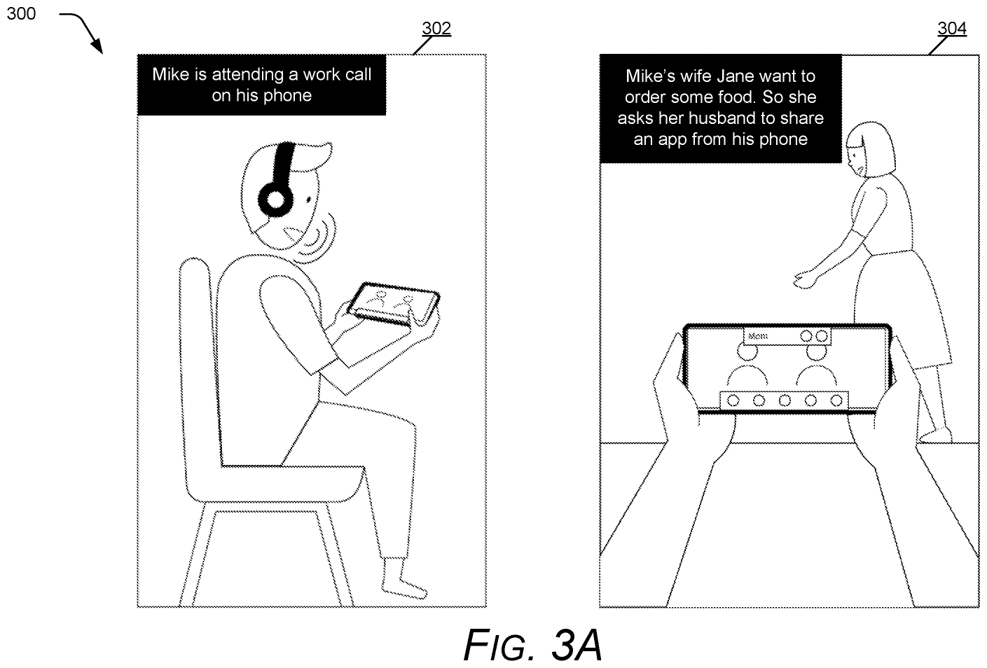

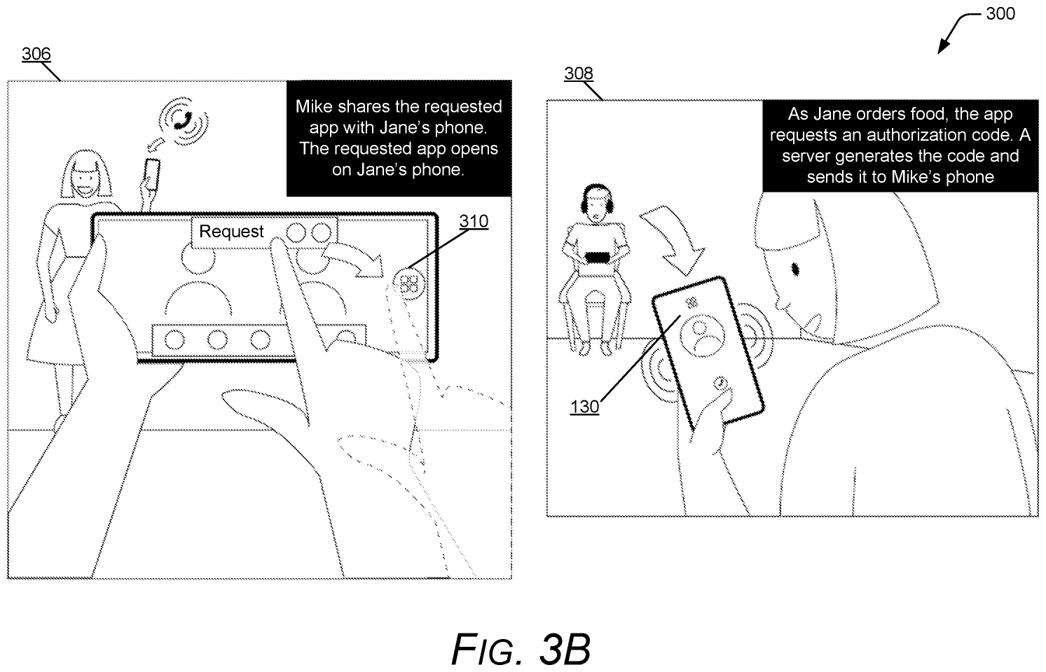

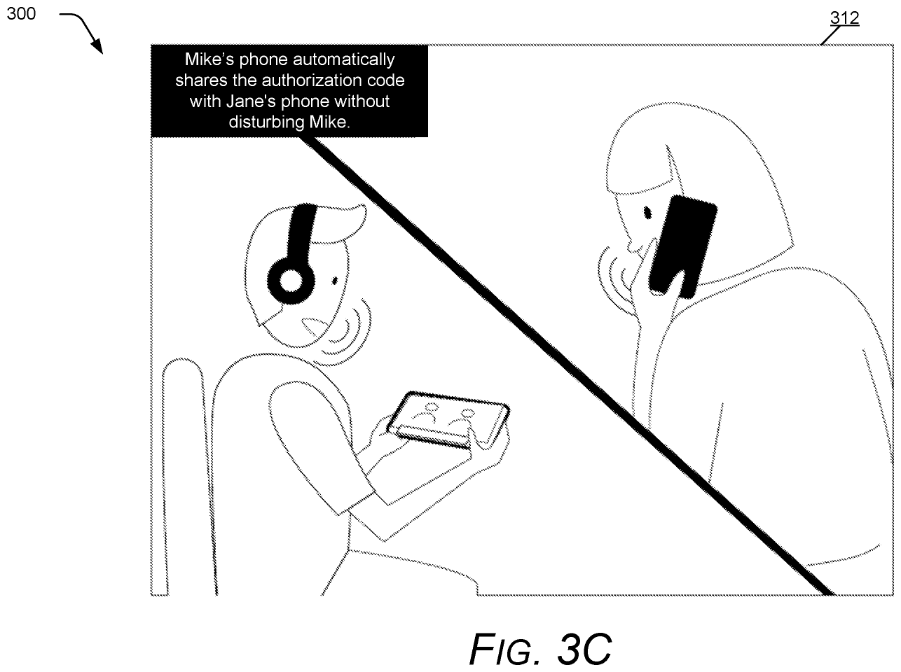

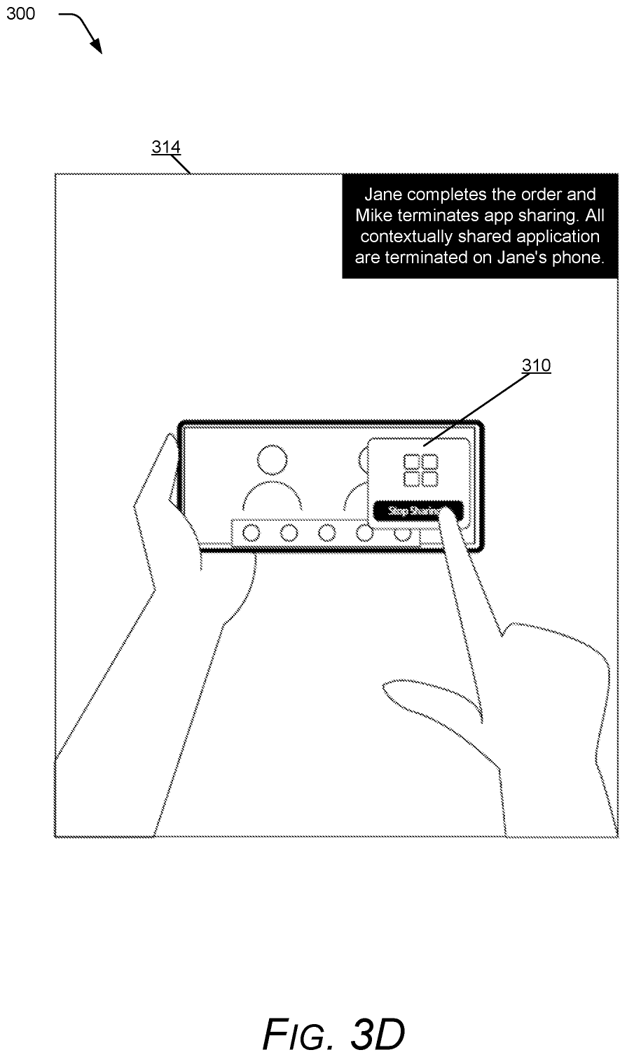

Example flow diagram 300, and methods 400 and 500 are described with reference to respective FIGS. 3A-3D, 4 and 5 in accordance with one or more implementations of event-based authorization transmission across mobile devices, as described herein. Generally, any services, components, modules, managers, controllers, methods, and/or operations described herein can be implemented using software, firmware, hardware (e.g., fixed logic circuitry), manual processing, or any combination thereof. Some operations of the example flow diagram and/or methods are described in the general context of executable instructions stored on computer-readable storage memory that is local and/or remote to a computer processing system, and one or more implementations include software applications, programs, functions, and the like. Alternatively or in addition, any of the functionality described herein is performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIGS. 3A-3D illustrate an example flow diagram 300 of event-based authorization transmission across mobile devices, as described herein. As shown, the flow diagram 300 depicts a storyboard flow diagram demonstrating the application and authorization transfer functionality described herein. In some configurations, the flow diagram 300 may be implemented by the application transfer controller 116 illustrated in FIG. 1 or 2. In some configurations, the flow diagram 300 may be implemented in conjunction with mobile device 102, mobile device 104, components thereof, or any combination thereof. The order in which a given flow diagram is described is not intended to be construed as a limitation, and any number or combination of flow diagram and/or method operations described herein (e.g., of FIGS. 3A, 3B, 3C, 3D, 4, 5, and/or 6) may be performed in any order to perform a flow diagram, a method, or an alternate method.

At 302, a user is attending an important work call on his mobile device (e.g., using a first application). For example, the user is attending a video call with one or more other persons on the video call. In implementations, the application transfer controller 116 detects that the user is on the video call (e.g., a first application).

At 304, the user receives a request to use a second application on the user's mobile device. For example, a notification of the request appears on the screen of the user's mobile device in relation to the ongoing work call also shown on the user's mobile device. However, the user needs to stay on the work call and cannot share his mobile device. In implementations, the application transfer controller 116 detects that the request to use a second application conflicts with the ongoing work call.

Referring to FIG. 3B, at 306, the user determines to share the second application with his wife's mobile device and the second application opens on the wife's mobile device. In implementations, the interface controller 120 provides an application transfer interface 310 to enable the user to transfer the second application to another user's mobile device (e.g., to his wife's mobile device). In the illustrated example, the application transfer controller 116 enables the user to drag the request to use the second application into an application transfer interface 310 provided by the interface controller 120.

At 308, as the wife uses the application transfer interface 130 to accept the second application. Additionally, or alternatively, the wife uses the application transfer interface 130 to handle and/or operate the second application on her mobile device. As the wife uses the second application, the second application requests an authorization code. Accordingly, a remote device (e.g., remote device 108) generates the authorization code and sends it to the user's mobile device.

Referring to FIG. 3C, at 312, the user's mobile device automatically transmits the authorization code with the wife's mobile device without disturbing the user or his call (e.g., without input from the user). Accordingly, the authorization code is entered and the wife is allowed to proceed to use the second application (e.g., to complete an order, to pay for an order, etc.).

Referring to FIG. 3D, at 314, the user of the mobile device determines, while still on the work call, that his wife has finished using the second application and the user terminates the sharing of the second application to his wife's mobile device using the application transfer interface 310 of the interface controller 120. Additionally, or alternatively, the user of the mobile device can determine, after the work call, that his wife has finished using the second application and the user then terminates the sharing of the second application to his wife's mobile device using the application transfer interface 310.

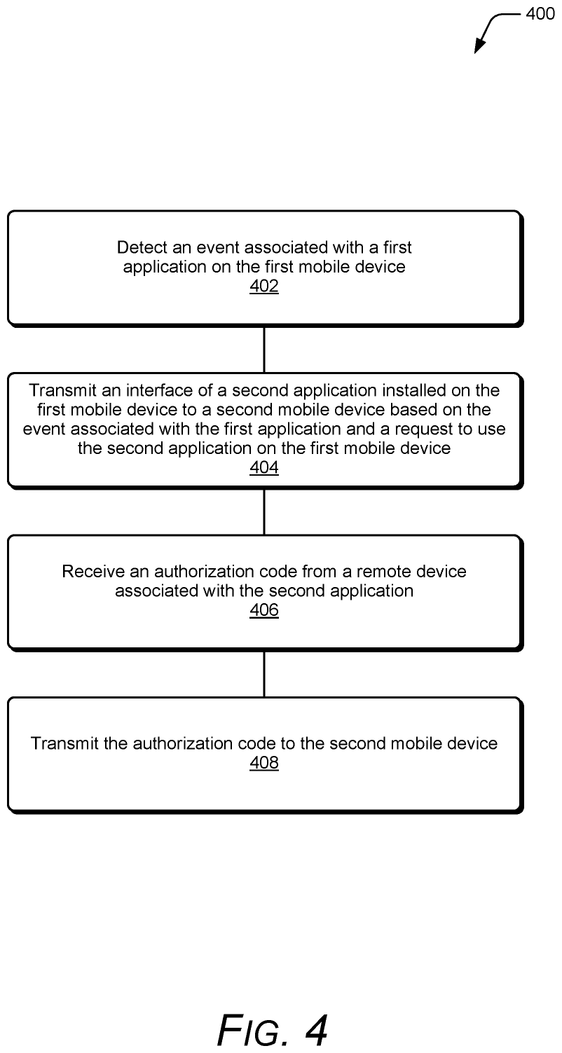

FIG. 4 illustrates example method(s) 400 for event-based authorization transmission across mobile devices. The order in which the method is described is not intended to be construed as a limitation, and any number or combination of the flow diagram and/or method operations described herein (e.g., of FIGS. 3A, 3B, 3C, 3D, 4, 5, and/or 6) may be performed in any order to perform a flow diagram, a method, or an alternate method.

At 402, the method 400 includes detecting an event associated with a first application on the first mobile device. For example, the application transfer controller 116 determines that a video call application (e.g., the first application) is currently running on the mobile device 102. Alternatively, the application transfer controller 116 determines that the video call application is scheduled to occur on the mobile device 102 (e.g., in 5 to 10 minutes, within the next hour, etc.).

At 404, the method 400 includes transmitting an interface of a second application installed on the first mobile device to a second mobile device based on the event associated with the first application and a request to use the second application that is installed on the first mobile device. For example, the application transfer controller 116 sends a request to the mobile device 104 to accept an interface of the second application (e.g., the application transfer interface 130). Based on an approval of the request, the application transfer controller 116 transmits an interface of the second application to the mobile device 104 (e.g., transmits instructions to generate an interface of the second application on the mobile device 104), enabling a user of the mobile device 104 to interact and/or control one or more aspects of the second application on the mobile device 104 while the second application executes on the mobile device 102 (e.g., concurrently with the first application executing on the mobile device 102).

At 406, the method 400 includes receiving an authorization code from a remote device associated with the second application. For example, the application transfer controller 116 obtains an authorization code based on an interaction of the second application on the mobile device 104. In some cases, the second application requests the authorization code from a remote device (e.g., the remote device 108) based on a user of the mobile device 104 interacting with the second application on the mobile device 104.

At 408, the method 400 includes transmitting the authorization code to the second mobile device. For example, the application transfer controller 116 transmits the authorization code to the mobile device 104.

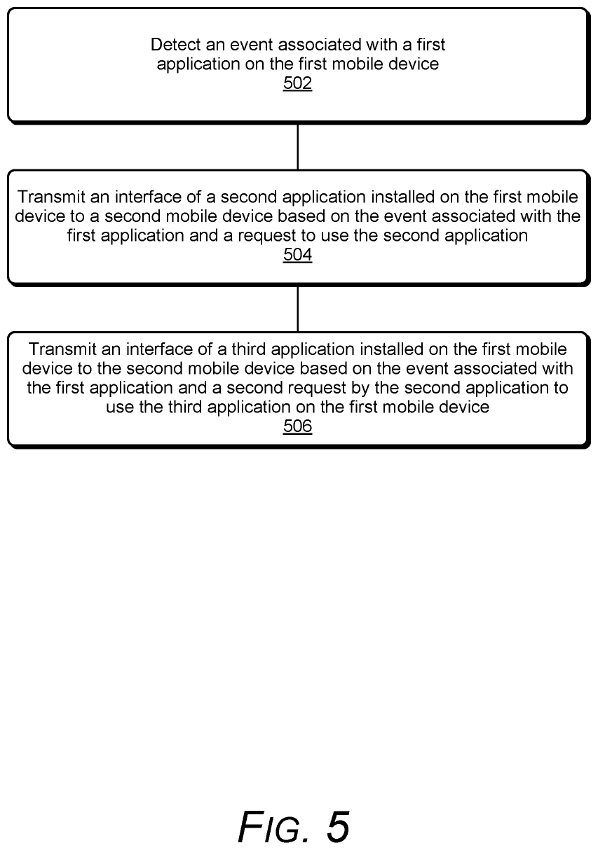

FIG. 5 illustrates example method(s) 500 for event-based authorization transmission across mobile devices. The order in which the method is described is not intended to be construed as a limitation, and any number or combination of the flow diagram and/or method operations described herein (e.g., of FIGS. 3A, 3B, 3C, 3D, 4, 5, and/or 6) may be performed in any order to perform a flow diagram, a method, or an alternate method.

At 502, the method 500 includes detecting an event associated with a first application on the first mobile device. For example, the application transfer controller 116 determines that a mobile application (e.g., the first application, device applications 114) is currently running on the mobile device 102. Alternatively, the application transfer controller 116 determines that the mobile application is scheduled to occur on the mobile device 102 (e.g., in 5 to 10 minutes, within the next hour, etc.).

At 504, the method 500 includes transmitting an interface of a second application installed on the first mobile device to a second mobile device based on the event associated with the first application and a request to use the second application that is installed on the first mobile device. For example, the application transfer controller 116 sends a request to the mobile device 104 to accept an interface of the second application (e.g., the application transfer interface 130). Based on an approval of the request (e.g., automatic approval based on policy, approval based on user input), the application transfer controller 116 transmits an interface of the second application to the mobile device 104 (e.g., transmits instructions to generate an interface of the second application on the mobile device 104), enabling a user of the mobile device 104 to interact and/or control one or more aspects of the second application on the mobile device 104 while the second application executes on the mobile device 102 (e.g., concurrently with the first application executing on the mobile device 102).

At 506, the method 500 includes. transmitting an interface of a third application installed on the first mobile device to the second mobile device based on the event associated with the first application and a second request by the second application to use the third application on the first mobile device. For example, the application transfer controller 116 sends a request to the mobile device 104 to accept an interface of the third application (e.g., via the application transfer interface 130). Additionally, or alternatively, the application transfer controller 116 sends a request to the mobile device 104 to accept a functionality of the third application enabled by second application and/or the application transfer interface 130 on the mobile device 104. Based on an approval of the request (e.g., automatic approval based on policy, approval based on user input), the application transfer controller 116 transmits an interface and/or functionality of the third application to the mobile device 104 (e.g., transmits instructions to generate an interface of the third application on the mobile device 104, and/or transmits instructions to enable a functionality of the third application on the mobile device 104), enabling a user of the mobile device 104 to interact and/or control one or more aspects of the third application on the mobile device 104 while the third application executes on the mobile device 102 (e.g., concurrently with the first application and/or the second application executing on the mobile device 102).

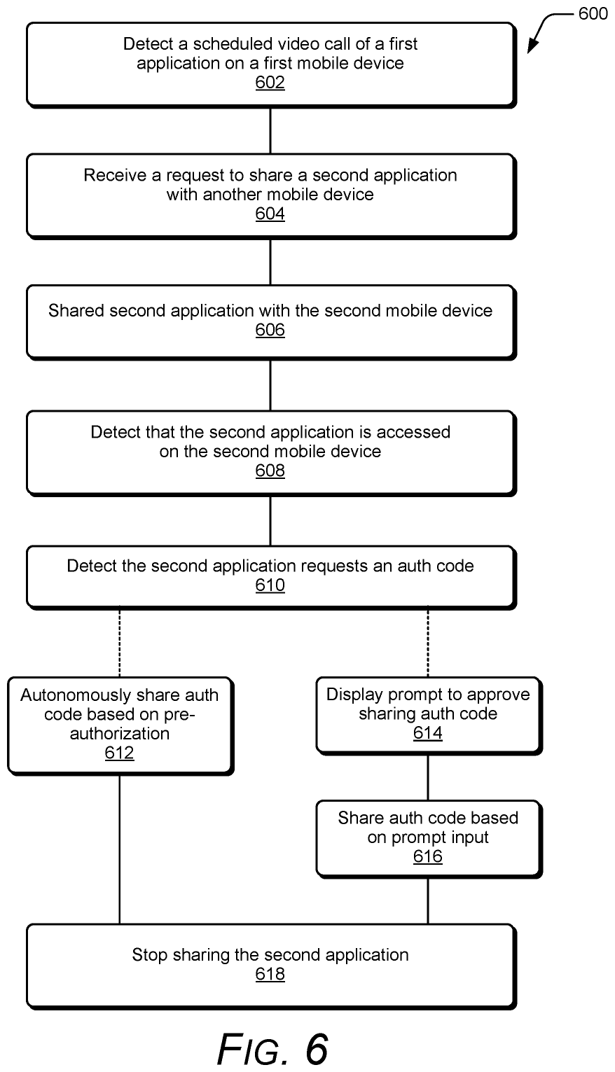

FIG. 6 illustrates example method(s) 600 for event-based authorization transmission across mobile devices. The order in which the method is described is not intended to be construed as a limitation, and any number or combination of the flow diagram and/or method operations described herein (e.g., of FIGS. 3A, 3B, 3C, 3D, 4, 5, and/or 6) may be performed in any order to perform a flow diagram, a method, or an alternate method.

At 602, the method 600 includes detecting a scheduled video call on a first mobile device. For example, the application transfer controller 116 determines that a video call is scheduled to occur on the mobile device 102 within the next five minutes.

At 604, the method 600 includes detecting a request to use a second application in relation to the scheduled video call. For example, the application transfer controller 116 identifies the request for the second application and determines that the request is from an approved device and/or approved user (e.g., a family member, a friend, a coworker, a neighbor, a person listed on the user's contacts, a device on a list of approved devices). Accordingly, the application transfer controller 116 displays a notification indicating that using the second application on the mobile device 102 potentially interferes with the scheduled video call. In example implementations, the video call is scheduled to occur using a wireless radio of the mobile device 102 (e.g., voice over Internet Protocol (VOIP) video call), and sharing the second application is over a cellular radio of the mobile device 102. Alternatively, the video call is scheduled to occur using a cellular radio of the mobile device 102, and sharing the second application is over a wireless radio of the mobile device 102.

At 606, the method 600 includes sharing the second application with the second mobile device. For example, the application transfer controller 116 receives user input at the mobile device 102 (e.g., voice input, touchscreen input, device physical button input, etc.) indicating to transfer control of the second application to a second mobile device (e.g., the mobile device 104). In example implementations, the application transfer controller 116 shares control of the second application with the mobile device 104 concurrently with the video call on the mobile device 102.

At 608, the method 600 includes detecting that the second application is accessed on the second mobile device. For example, the application transfer controller 116 receives monitoring information indicating that the second application and/or an interface of the second application is accessed on the mobile device 104.

At 610, the method 600 includes detecting that the second application requests an authorization code. For example, the application transfer controller 116 detects an authorization code is received at the mobile device 102. In some cases, the application transfer controller 116 detects that the authorization code is associated with the second application.

At 612, the method 600 optionally includes autonomously sharing the authorization code based on a pre-authorization. For example, the application transfer controller 116 determines that an authorization code is received based on the second application being shared, the application transfer controller 116 autonomously shares the authorization code with the mobile device 104 (e.g., with the interface of the second application on the mobile device 104, with the device interface module 124). In some cases, the application transfer controller 116 autonomously shares the authorization code based on the second application being on a list of applications approved for autonomous sharing and/or the mobile device 104 being on a list of devices approved for autonomous sharing.

At 618, the method 600 includes terminating the sharing of the second application. For example, the application transfer controller 116 stops sharing the second application based on an input at the mobile device 102 and/or the application transfer controller 116 detecting that the second application is closed on the mobile device 104.

At 614, the method 600 optionally includes displaying a prompt to approve the sharing of the authorization code. For example, the application transfer controller 116 generates a prompt based on detecting the request for the authorization code from the second application. The prompt may include one or more interface buttons that enable a user of the mobile device 102 to accept the sharing of the authorization code and/or the deny the sharing of the authorization code.

At 616, the method 600 includes sharing the authorization code based on prompt input. For example, the application transfer controller 116 detects that an approval to share the authorization code is received via the prompt (e.g., detecting an approval graphical interface button of the prompt being selected). Accordingly, the application transfer controller 116 shares the authorization code with the second application (e.g., with the interface of the second application on the mobile device 104, with the device interface module 124).

At 618, the method 600 includes terminating the sharing of the second application (e.g., based on input at the first mobile device and/or based on monitoring information indicating the second application is closed on the second mobile device). For example, the application transfer controller 116 detects an input at the mobile device 102 to stop sharing the second application. Additionally, or alternatively, the application transfer controller 116 detects, based on the monitoring information, that the second application is closed on the mobile device 104. In response, the application transfer controller 116 terminates the sharing of the second application to the second mobile device. For instance, the application transfer controller 116 instructs the mobile device 102 (e.g., the operating system 118 of the mobile device 102) to terminate execution of the sharing of the second application (e.g., the second application 134) from the mobile device 102. As a result, sharing of the second application with the mobile device 104 is terminated.

FIG. 7 illustrates various components of an example device 700, which can implement aspects of the techniques and features for event-based authorization transmission across mobile devices, as described herein. The example device 700 may be implemented as any of the devices described with reference to the previous FIGS. 1-5, such as any type of a wireless device, mobile device, mobile phone, flip phone, client device, companion device, paired device, display device, tablet, computing, communication, entertainment, gaming, media playback, and/or any other type of computing and/or electronic device. For example, the mobile device 102 and/or the mobile device 104 described with reference to FIGS. 1-5 may be implemented as the example device 700.

The example device 700 can include various, different communication devices 702 that enable wired and/or wireless communication of device data 704 with other devices. The device data 704 can include any of the various devices data and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various, different types of data input/output (I/O) interfaces 706, such as data network interfaces that provide connection and/or communication links between the devices, data networks, and other devices. The I/O interfaces 706 may be used to couple the device to any type of components, peripherals, and/or accessory devices, such as a computer input device that may be integrated with the example device 700. The I/O interfaces 706 may also include data input ports via which any type of data, information, media content, communications, messages, and/or inputs may be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 712 include volatile memory and non-volatile memory, fixed and removable mobile devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage mobile device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 may be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In one or more examples, the device 700 includes an application transfer controller 718 that implements various aspects of the described features and techniques described herein. The application transfer controller 718 is implemented with hardware components and/or in software as one of the device applications 714, such as when the example device 700 is implemented as the mobile device 102 and/or the mobile device 104 described with reference to FIGS. 1-5. An example of the application transfer controller 718 is the application transfer controller 116 implemented by the mobile device 102 and/or the mobile device 104, such as a software application and/or as hardware components in the mobile device 102 and/or in the mobile device 104. In implementations, the application transfer controller 718 includes independent processing, memory, and logic components as a computing and/or electronic device integrated with the example device 700.

The example device 700 can also include a microphone 720 (e.g., to capture an audio recording of a user) and/or camera devices 722 (e.g., to capture video images of the user during a call), as well as motion sensors 724, such as may be implemented as components of an inertial measurement unit (IMU). The motion sensors 724 may be implemented with various sensors, such as a gyroscope, an accelerometer, and/or other types of motion sensors to sense motion of the device. The motion sensors 724 can generate sensor data vectors having three-dimensional parameters (e.g., rotational vectors in x, y, and z-axis coordinates) indicating location, position, acceleration, rotational speed, and/or orientation of the device. The example device 700 can also include one or more power sources 726, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 700 can also include an audio and/or video processing system 728 that generates audio data for an audio system 730 and/or generates display data for a display system 732. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 700. Alternatively, the audio system and/or the display system are external, peripheral components to the example device.

Although implementations for event-based authorization transmission across mobile devices have been described in language specific to features and/or methods, the appended claims are not necessarily limited to the specific features or methods described. Rather, the specific features and methods are disclosed as example implementations for event-based authorization transmission across mobile devices, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a first mobile device, including: at least one memory; and at least one processor coupled with the at least one memory configured to cause the first mobile device to: detect an event associated with a first application on the first mobile device; transmit an interface of a second application installed on the first mobile device to a second mobile device based on the event associated with the first application and a request to use the second application on the first mobile device; receive an authorization code from a remote device associated with the second application; and transmit the authorization code to the second mobile device.

In some aspects, the techniques described herein relate to a first mobile device, wherein the first application and the second application execute concurrently on the first mobile device.

In some aspects, the techniques described herein relate to a first mobile device, wherein the at least one processor is configured to display, in response to receiving the authorization code, a prompt to approve transmitting the authorization code to the second mobile device, wherein the first mobile device transmits the authorization code based on the first mobile device detecting an approval to transmit the authorization code in response to display of the prompt.

In some aspects, the techniques described herein relate to a first mobile device, wherein the first mobile device transmits at least one of the interface of the second application or the authorization code automatically based on a preconfigured policy.

In some aspects, the techniques described herein relate to a first mobile device, wherein: the preconfigured policy includes at least one of a list of authorized mobile devices or a list of unauthorized mobile devices, and transmitting at least one of the interface of the second application or the authorization code automatically is based on the second mobile device being on the list of authorized mobile devices.

In some aspects, the techniques described herein relate to a first mobile device, wherein: the preconfigured policy includes at least one of a list of authorized applications or a list of unauthorized applications, and transmitting at least one of the interface of the second application or the authorization code automatically is based on the second application being on the list of authorized applications.

In some aspects, the techniques described herein relate to a first mobile device, wherein the at least one processor is configured to cause the first mobile device to: receive the authorization code via the second application on the first mobile device; and transmit the authorization code to the second mobile device via the second application.

In some aspects, the techniques described herein relate to a first mobile device, wherein the at least one processor is configured to cause the first mobile device to: receive the authorization code via a text messaging application of the first mobile device; and transmit the authorization code to the second mobile device via the second application based on the second application acquiring the authorization code from the text messaging application.

In some aspects, the techniques described herein relate to a first mobile device, wherein: the event includes an active use of the first application on the first mobile device at a time of the request; or the event includes a scheduled use of the first application on the first mobile device that conflicts with using the second application on the first mobile device.

In some aspects, the techniques described herein relate to a first mobile device, wherein the request to use the second application includes at least one of a notification on a display of the first mobile device, or a message received at the first mobile device.

In some aspects, the techniques described herein relate to a first mobile device, wherein the interface of the second application is transmitted in response to an approval of the request received at the first mobile device.

In some aspects, the techniques described herein relate to a first mobile device, wherein the at least one processor is configured to cause the first mobile device to terminate transmission of the interface of the second application to the second mobile device based on monitoring information of the second application indicating that the second application is closed on the second mobile device or based on user input received at the first mobile device.

In some aspects, the techniques described herein relate to a first mobile device, wherein the interface of the second application transmitted to the second mobile device differs from an interface displayed on the first mobile device that is associated with the second application.

In some aspects, the techniques described herein relate to a first mobile device, wherein: the first application utilizes a first wireless technology; and the second application utilizes a second wireless technology different from the first wireless technology.

In some aspects, the techniques described herein relate to a first mobile device, including: at least one memory; and at least one processor coupled with the at least one memory configured to cause the first mobile device to: detect an event associated with a first application on the first mobile device; transmit an interface of a second application installed on the first mobile device to a second mobile device based on the event associated with the first application and a first request by a user to use the second application on the first mobile device; and transmit an interface of a third application installed on the first mobile device to the second mobile device based on the event associated with the first application and a second request by the second application to use the third application on the first mobile device.

In some aspects, the techniques described herein relate to a first mobile device, wherein the first mobile device transmits at least one of the interface of the second application or the interface of the third application automatically based on a preconfigured policy.

In some aspects, the techniques described herein relate to a first mobile device, wherein: the preconfigured policy includes at least one of a list of authorized mobile devices or a list of unauthorized mobile devices, and transmitting at least one of the interface of the second application or the interface of the third application automatically is based on the second mobile device being on the list of authorized mobile devices.

In some aspects, the techniques described herein relate to a first mobile device, wherein: the preconfigured policy includes at least one of a list of authorized applications or a list of unauthorized applications, and transmitting at least one of the interface of the second application or the interface of the third application automatically is based on at least one of the second application or the third application being on the list of authorized applications.

In some aspects, the techniques described herein relate to a first mobile device, wherein the at least one processor is configured to cause the first mobile device to terminate transmission of at least one of the interface of the second application or the interface of the third application to the second mobile device based on user input received at the first mobile device or based on monitoring information of at least one of the second application or the third application indicating that at least one of the second application or the third application is closed on the second mobile device.

In some aspects, the techniques described herein relate to a method, including: detecting an event associated with a first application on a first mobile device; transmitting an interface of a second application installed on the first mobile device to a second mobile device based on the event associated with the first application and a request to use the second application on the first mobile device; receiving an authorization code from a remote device associated with the second application; and transmitting the authorization code to the second mobile device.

What is claimed:

1. A first mobile device, comprising:
at least one memory; and
at least one processor coupled with the at least one memory configured to cause the first mobile device to:
detect an event associated with a first application on the first mobile device;
transmit an interface of a second application installed on the first mobile device to a second mobile device based on the event associated with the first application and a request to use the second application;
receive an authorization code from a remote device associated with the second application; and
transmit the authorization code to the second mobile device.

2. The first mobile device of claim 1, wherein the first application and the second application execute concurrently on the first mobile device.

3. The first mobile device of claim 1, wherein the at least one processor is configured to display, in response to receiving the authorization code, a prompt to approve transmitting the authorization code to the second mobile device, wherein the first mobile device transmits the authorization code based on the first mobile device detecting an approval to transmit the authorization code in response to display of the prompt.

4. The first mobile device of claim 1, wherein the first mobile device transmits at least one of the interface of the second application or the authorization code automatically based on a preconfigured policy.

5. The first mobile device of claim 4, wherein:
the preconfigured policy comprises at least one of a list of authorized mobile devices or a list of unauthorized mobile devices, and
transmitting at least one of the interface of the second application or the authorization code automatically is based on the second mobile device being on the list of authorized mobile devices.

6. The first mobile device of claim 4, wherein:
the preconfigured policy comprises at least one of a list of authorized applications or a list of unauthorized applications, and
transmitting at least one of the interface of the second application or the authorization code automatically is based on the second application being on the list of authorized applications.

7. The first mobile device of claim 1, wherein the at least one processor is configured to cause the first mobile device to:
receive the authorization code via the second application on the first mobile device; and
transmit the authorization code to the second mobile device via the second application.

8. The first mobile device of claim 1, wherein the at least one processor is configured to cause the first mobile device to:
receive the authorization code via a text messaging application of the first mobile device; and
transmit the authorization code to the second mobile device via the second application based on the second application acquiring the authorization code from the text messaging application.

9. The first mobile device of claim 1, wherein:
the event includes an active use of the first application on the first mobile device at a time of the request; or
the event includes a scheduled use of the first application on the first mobile device that conflicts with using the second application on the first mobile device.

10. The first mobile device of claim 1, wherein the request to use the second application includes at least one of a notification on a display of the first mobile device or a message received at the first mobile device.

11. The first mobile device of claim 1, wherein the interface of the second application is transmitted in response to an approval of the request received at the first mobile device.

12. The first mobile device of claim 1, wherein the at least one processor is configured to cause the first mobile device to terminate transmission of the interface of the second application to the second mobile device based on monitoring information of the second application indicating that the second application is closed on the second mobile device or based on user input received at the first mobile device.

13. The first mobile device of claim 1, wherein the interface of the second application transmitted to the second mobile device differs from an interface displayed on the first mobile device that is associated with the second application.

14. The first mobile device of claim 1, wherein:
the first application utilizes a first wireless technology; and
the second application utilizes a second wireless technology different from the first wireless technology.

15. A first mobile device, comprising:
at least one memory; and
at least one processor coupled with the at least one memory configured to cause the first mobile device to:
detect an event associated with a first application on the first mobile device;
transmit an interface of a second application installed on the first mobile device to a second mobile device based on the event associated with the first application and a first request to use the second application; and
transmit an interface of a third application installed on the first mobile device to the second mobile device based on the event associated with the first application and a second request by the second application used on the second mobile device to use the third application.

16. The first mobile device of claim 15, wherein the first mobile device transmits at least one of the interface of the second application or the interface of the third application automatically based on a preconfigured policy.

17. The first mobile device of claim 16, wherein:
the preconfigured policy comprises at least one of a list of authorized mobile devices or a list of unauthorized mobile devices, and
transmitting at least one of the interface of the second application or the interface of the third application automatically is based on the second mobile device being on the list of authorized mobile devices.

18. The first mobile device of claim 16, wherein:
the preconfigured policy comprises at least one of a list of authorized applications or a list of unauthorized applications, and
transmitting at least one of the interface of the second application or the interface of the third application automatically is based on at least one of the second application or the third application being on the list of authorized applications.

19. The first mobile device of claim 15, wherein the at least one processor is configured to cause the first mobile device to terminate transmission of at least one of the interface of the second application or the interface of the third application to the second mobile device based on user input received at the first mobile device or based on monitoring information of at least one of the second application or the third application indicating that at least one of the second application or the third application is closed on the second mobile device.

20. A method, comprising:
detecting an event associated with a first application on a first mobile device;
transmitting an interface of a second application installed on the first mobile device to a second mobile device based on the event associated with the first application and a request to use the second application;
receiving an authorization code from a remote device associated with the second application; and
transmitting the authorization code to the second mobile device.
